(19) United States
(12) Patent Application Publication
(10) Pub. No.: US 2010/0268670 A1
(43) Pub. Date: Oct. 21, 2010

(54) Method And Tool For Retirement Income Management

(75) Inventors: Kenneth Alfred Dahlberg, St. Paul, MN (US); Stephen Michael Fredlund, North Branch, MN (US)

Correspondence Address: FITCH EVEN TABIN & FLANNERY, 120 SOUTH LASALLE STREET, SUITE 1600, CHICAGO, IL, 60603-3406, US

(73) Assignee: THRIVENT FINANCIAL FOR LUTHERANS, Appleton, WI (US)

(21) Appl. No.: 12/825,206

(22) Filed: Jun. 28, 2010

Related U.S. Application Data
(63) Continuation of application No. 11/598,368, filed on Nov. 13, 2006.

(51) Int. Cl. G06Q 40/00

(52) U.S. Cl. 705/36 R

(57) ABSTRACT

The present invention is a method of monitoring a retirement income plan and managing retirement income through use of a retirement income planning tool. The retirement income planning tool is comprised of modules working together in order to facilitate planning, monitoring, management and generation of a retirement income plan. The projected assets are generated in response to the processing of financial data input into the retirement income planning tool in view of potential investment performance scenarios. The financial data input into the retirement income planning tool includes at least a customer's desired retirement income levels, assets level and retirement compensation levels. The retirement income plan is comprised of at least data representative of projected retirement compensation, asset levels and projected asset withdrawals. The retirement income planning tool compares a client's retirement compensation to the comprehensive retirement income levels desired in order to determine the level of asset withdrawals necessary to achieve the comprehensive retirement income levels. The method of monitoring includes guidelines for dynamic management and monitoring of retirement asset withdrawals and investments in order to facilitate retirement asset utilization over the life of the retirement income plan.

### FIELD

The invention relates generally to the field of financial advisory services. More particularly, the invention relates to a method of monitoring and advising an investor on achieving retirement income levels that can be sustained over the life of a retirement plan.

### BACKGROUND

Over the past several years, there has been movement away from using defined benefit plans as a way to facilitate retirement savings and a shift towards employee-directed defined contribution plans like 401(k). As this trend continues, many individual investors will ultimately become responsible for managing their own retirement investments. However, many people are not well-equipped to make informed investment decisions. Further, the number and diversity of investment options available to individuals is rapidly increasing, thereby making investment decisions more complex by the day. In addition, due to the complexity involved with securing a retirement income that meets a customer's desires, decisions and the associated risks taken today may not be right for tomorrow as the customer gets closer to retirement. Accordingly, proper management has to be based on current market conditions prior market performance, risks involved with specific investments, and age of the investor.

In the past, prior art systems have been typically referred to as “retirement calculators.” These systems require the user to provide estimates of future inflation, interest rates, the expected return on their investments and their expected life termination. In this type of prior art system, the user is likely, and is in fact encouraged, to simply increase the expected investment returns until their desired portfolio value is achieved. One of the problems with this approach is that the user of the program is likely to create an unattainable portfolio based on an unrealistic set of future economic scenarios. For example, if the client's portfolio of financial products is required to achieve a high percentage of growth per year in order to meet the client's retirement goals, the goals may not be attainable because the growth levels are not be available to the user. In addition, assuming high growth on investments in every year, with no inflation, may not be macroeconomically consistent. Typical prior art investment packages simply allow the user to manipulate economic conditions until a desired result is achieved rather than encouraging the user to focus on their own decisions regarding investment risk, savings rate, and retirement age within the context of realistic economic assumptions. Consequently, the so called “advice” rendered by many of the prior art investment software packages can be misleading and impossible to implement in practice. There is a need for a system that prompts a customer to consider historical investment growth along with investment risk, savings rate, and retirement age during the retirement income planning and management process.

Other prior art systems contain a routine to help consumers “optimize” their investment choices, but these systems also are built on the use of static initial parameters. In addition, these systems require the consumer to supply their “utility functions”, or their preference for different outcomes in order to determine the optimal result. This is a difficult exercise for most consumers who don't have a deep understanding of the impacts of the different choices they are faced with. Optimization routines also provide an answer that gives the best statistical results across many scenarios, but each consumer will actually experience only one scenario and the choices that work out best in most scenarios might not be the best choices in the scenario that they actually experience.

In view of the foregoing, there is a need for a retirement income management and planning methodology and supporting software package that overcomes the problems of the prior “retirement calculator” systems. Such a system may overcome these problems by using multiple scenarios of potential market conditions to demonstrate a range of possible results. Such a system is an improvement over the simplistic assumptions of the “retirement calculators”, and would help clients using the system with making realistic planning decisions. Such a system shall implement a method that focuses an individual on the financial decisions available to them today and demonstrate how those decisions will affect their respective income during retirement. The method must also be dynamic and provide specific rules and guidelines to help the client adjust their plan by taking certain actions under certain circumstances to improve the likelihood of achieving their financial goals.

### SUMMARY

According to aspects of various described embodiments, the present invention is a method of monitoring and managing retirement income through use of a retirement income planning tool. The retirement income planning tool is comprised of software modules operative in a computing environment whereby the modules communicate and process financial and personal data to facilitate planning, monitoring, management and generation of a retirement income plan. A first step of the method involves the input of financial data. The financial data includes at least a customer's desired retirement income levels, current asset level and alternative sources of retirement compensation. Next, data representative of the current assets level are allocated into at least one investment vehicle. The at least one investment vehicle is an asset performance projection module within the retirement income planning tool configured to project the performance of a client's assets when processed in view of a plurality of alternative investment scenarios. Each of the plurality of investment scenarios are modeled to project investment changes in retirement assets hypothetically invested into hundreds of randomly generated investment scenarios. Next, the retirement income planning tool's planning module generates a retirement income plan including at least data representative of projected retirement compensation, projected asset levels and projected asset withdrawals. The projected assets comprise data representative of the projected performance of the client assets that have been processed by the performance projection module. The planning module also illustrates a client's projected retirement income from sources other than assets, and the gap between the combined total of these income sources and the client's desired retirement income level. The planning module fills this income gap by managing the withdrawal of retirement assets that are combined with the retirement income from sources in order to achieve a retirement income level equal to that desired by the client. The planning module further includes asset withdrawal guidelines which notify a client when retirement asset withdrawals reach levels which are not sustainable over the life of the retirement income plan. The method further includes the step of identifying at least one date within a retirement income plan when it is advantageous to purchase an annuity and providing the customer with an option to purchase and incorporate the annuity revenue into the retirement income plan. The date identified is in accordance with when the annuity payout rate is not greater than the withdrawal rate of retirement assets over a defined period of time. The retirement assets are managed in at least two accounts, an income buffer account, from which income withdrawals are made and an asset growth account.

### BRIEF DESCRIPTION OF THE FIGURES

Non-limiting and non-exhaustive embodiments are described with reference to the following figures, wherein like reference numerals refer to like parts throughout the various views unless otherwise specified.

FIG. 1 is a diagram illustrating an exemplary system for monitoring and managing projected and actual retirement income, according to one embodiment;

FIG. 2 is a diagram illustrating an exemplary system for monitoring and managing projected and actual retirement income, according to one embodiment;

FIG. 3 is a flow diagram illustrating operational flow of the method of monitoring and managing projected and actual retirement income, according to one embodiment;

FIG. 4 is a flow diagram illustrating continued operational flow of the method of monitoring and managing projected and actual retirement income, according to one embodiment;

FIG. 5 is a flow diagram illustrating continued operational flow of the method of monitoring and managing projected and actual retirement income, according to one embodiment;

FIG. 6 is a flow diagram illustrating continued operational flow of the method of monitoring and managing projected and actual retirement income, according to one embodiment;

FIG. 7 is a flow diagram illustrating continued operational flow of the method of monitoring and managing projected and actual retirement income, according to one embodiment;

FIG. 8 is a graphic illustration of a retirement income goal, whereby the client's desired income is illustrated as a combination of withdrawals from assets and income from retirement income sources;

FIG. 9 is a graphic illustration of the percent of scenarios that meet the total income targets in defined years;

FIG. 10 is a graphic illustration of the range if income results across scenarios; and

FIG. 11 is a graphic illustration of the range of the remaining asset values throughout the projection.

### DETAILED DESCRIPTION

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. It is to be understood that embodiments may be practiced as steps, some of which may be implemented through use of computer systems. Embodiments may be implemented as a computer process, a computer system or as an article of manufacture such as a computer program product. The computer program product may be computer storage medium readable by a computer system and encoding a computer program of instructions for executing a computer process. The computer program product may also be a propagated signal on a carrier readable by a computing system and encoding a computer program of instructions for executing a computer process.

The present invention is a method of monitoring and managing retirement income through use of a retirement income planning tool. The retirement income planning tool is a computer implemented software module that facilitates the modeling of various investment decisions, the effects of which are projected and illustrated, in view of the client's retirement assets and other forms of compensation during retirement. The decisions may have a positive or negative impact on a client's income stream during a selected retirement period when the client's assets to be invested and the proposed asset management decisions are processed by the software module's asset performance projection component which is configured to project the performance of a customer's investment assets in a plurality of alternative investment scenarios. The planning tool's asset performance projection component uses several hundred “random” investment scenarios that are generated using complex statistical methods that are operative within the module in order to generate client specific investment scenarios that have statistical characteristics similar to those that have been observed historically. These characteristics include the average value and the annual variation for factors such as interest rates, market returns, and inflation, as well as any correlation between the factors. The scenarios used in the planning tool's asset performance projection component are based on historical parameters for large company stocks (for example S&P 500), corporate bonds (for example Salomon Brothers Long-Term High Grade Corporate Bond Index), and seven year U.S. Treasury bonds and inflation (for example CPI, All Urban Consumers, Not Seasonally Adjusted).

Retirement income investment scenarios compare a user's current investment and asset management strategies with the client's future income needs in retirement. An individual scenario is a set of year-by-year market returns and inflation rates over a defined period of time. In the present embodiment, the year-by-year market returns are reflective of stock and bond returns along with treasury interest rates and inflation rates over a 60 year period of time. The retirement income planning tool generates data reflecting the likelihood of whether a retirement income plan a client defines shall satisfy a client's retirement income needs. This determination is made in view of asset management decisions and the projected performance of the client's assets when invested in a multitude of alternative investment scenarios, in combination with the client's other retirement income sources, such as additional savings and annuities.

Upon accessing the planning module of the retirement income tool, a user defines whether the plan applies to a couple or an individual and then inputs at least a client's name(s), birth date(s) and age(s) or birth date(s). When birth date(s) is entered, the tool determines the client age(s). The user must also enter an age at which the income distribution to the client is to begin. This allows the client to define the start of their respective income distribution plan at some time into the future, without requiring detailed budget information for the period of time before the plan starts. Next, the user is prompted to input important client financial information into the tool, including at least expected expenses at retirement, retirement income sources (such as social security benefits and company pension plans) and total retirement income assets (such as retirement savings, IRAs, 401(k)s, 457s, 403(b)s, variable annuities, CDs, fixed annuities, mutual funds and general securities). This financial information is processed by the planning module of the retirement income planning tool in order to generate a year-by-year cash flow analysis and projection of a client's retirement income. When there is a gap between the client's defined income needs and income sources (compensation sources other than assets), the planning module facilitates filling the gap with a combination of withdrawals from the client's retirement assets and hypothetical annuity payments which are included in the assets if annuities are included in the retirement income plan.

In order to determine how long a client may be able to generate income from their total retirement asset resultant values, the retirement income planning tool will combine the investment assets into one pool of assets and project future retirement asset hypothetically invested in hundreds of randomly generated investment scenarios. The process of projecting future values of retirement assets is a planning strategy that utilizes a variety of potential economic factors that effect each scenario that include interest rates, market returns and inflation. All of these factors are generated from data representative of historical interest rates, market returns and inflation, which makes the projections more reflective of realistic scenarios. For each scenario, the process projects retirement asset values into the future to determine the potential investment experience. Repeating this process over several hundred scenarios creates an understanding of the range of potential outcomes of an investment strategy and how various economic conditions can have a positive or negative impact on the strategy.

The planning method further includes a step of identifying at least one date within the retirement income plan when it is advantageous to purchase an annuity and provides the customer with an option to purchase and incorporate the annuity revenue into the retirement income plan. The date identified is in accordance with when the annuity payout rate is not greater than the current withdrawal rate of a defined period of time. The retirement income planning tool is configured to incorporate the purchase and income from an annuity into a retirement income plan when the plan reflects information recommending the purchase of some amount of guaranteed lifetime income. Annuity purchases may occur at the beginning of a retirement plan or during the plan in accordance with planning module “Income Lock” guidelines, which are suggestions by the planning module at periodic intervals during a retirement income plan for the purchase of guaranteed lifetime income under certain conditions.

When an annuity is purchased at the start of a retirement income plan, the client builds a floor or guaranteed minimum level of income into the retirement income plan that a client is guaranteed over the life of the income plan or a specified period. The input into the planning module of the retirement income planning tool is the amount of guaranteed income a client desires to purchase. In response, the retirement income planning tool determines the approximate purchase price.

When a client inputs data into the retirement income planning tool reflecting a desire to purchase an annuity and apply the planning module's “Income Lock” guidelines, the income lock guidelines within the planning module of the retirement income planning tool may be applied in the income projection upon acceptance of the option to purchase an annuity by the client. In accordance with the income lock guidelines, the retirement income planning tool will suggest, at periodic intervals, the purchase of guaranteed lifetime income under certain conditions. In accordance with one embodiment, those conditions are met when the annuity payout rate is not greater than the asset withdrawal rate of a current period. If a client exercises the option of purchasing an annuity, the annuity purchase facilitates the addition of a component of guaranteed income into the retirement income plan at a cost that is less than that of the scheduled retirement asset withdrawal amount.

The required input into the planning module of the retirement income planning tool when a client is making a purchase of an annuity, in accordance with one embodiment, are expressed as a percent of remaining assets to be used for the purchase lifetime income in any given year. For example, the plan could be to use 10% or 15% of a client's assets to buy additional guaranteed lifetime income in any year when income lock guideline conditions are met. Income lock guideline conditions are met when the annuity purchase rate (amount of annual income available from the annuity divided by the premium) is equal or less than a scheduled/projected withdrawal rate of assets necessary to fill an income gap in a particular year.

In addition to projecting the performance of assets in view of investment scenarios, the assets are managed in a manner that facilitates meeting the client's retirement income needs. In that regard, assets are managed through the use of at least two accounts. An income buffer account and a growth account. The income buffer account includes a portion of the retirement assets that are maintained as liquid in order to allow for the withdrawal of assets for use as retirement income.

The retirement income planning tool is also configured to emit a warning indicator when withdrawals of retirement assets reach levels that are not sustainable over the life of the projected retirement income plan. This function, characterized as “Income Extender,” is a sub module within the planning module that includes guidelines for managing withdrawals of retirement assets. “Income Extender” is an early warning application within the retirement income planning tool that is applied to retirement income withdrawals, indicating when retirement asset withdrawals reach levels that are not sustainable over the life of the retirement income plan. Withdrawals which initially may have been okay in a retirement income plan, in view of projections, may eventually reveal themselves as unworkable over the life of a retirement income plan when there are poor returns on investment, high inflation or both. In accordance with one embodiment, the “Income Extender” guidelines recommend that withdrawals not exceed 8% of retirement assets in any given year. This maximum recommended withdrawal rate increases to 9% for ages 85-89 and 10% for ages 90 and above.

Initial data input into the retirement income planning tool is a user(s) name(s) and birthdate(s). It is to be understood that the retirement income planning tool allows the generation of a retirement income plan for an individual or couples. The planning module within the retirement income tool automatically facilitates calculation of a client's current age(s). The function of allowing the user to project a client's income distribution at an age of the client's choice allows the client to indicate the start of their distribution plan a few years into the future, without requiring detailed budget information for the years before the plan starts. Next, the tool allows the user to input client data reflective of the current balance of several different accounts that collectively reflect the client's assets. It is the total current amount of the client's assets, along with the other income sources, that is used in the retirement income projection.

The retirement income planning tool models both a current investment allocation and potential alternative investment allocation for retirement assets. In accordance with one embodiment, a client is provided with at least five choices representing a range of investment allocations. The specific allocations are modeled as a mix of large company stock funds and corporate bond funds as indicated in table 1 below.

TABLE 1

| | Large Company | Long Term High |
|---|---|---|
| Investment Allocation | Stocks | Grade Corp. Bonds |
| Conservative | 20% | 80% |
| Moderately Conservative | 40% | 60% |
| Moderate | 60% | 40% |
| Moderately Aggressive | 70% | 30% |
| Aggressive | 85% | 15% |

The returns from each individual asset class are blended according to the selected mix. The calculations assume annual rebalancing so that the proportion of assets in each asset class is constant from year to year. Because the historical parameters used to generate the random scenarios for this projection are based on returns of various indexes, a general assumption regarding investment fees and expenses is included in the calculations.

Example calculations:

Investment Allocation=Moderately Aggressive (70% stock/30% bond)

Annual investment loads/fees=1.50%

Year 1; Stock return=11.62%; Bond return=5.38%;

Projected Investment return=(70%×11.62%)+(30%×5.38%)−1.50%=8.25%

Year 5; Stock return=−24.90%; Bond return=6.72%;

Projected Investment return=(70%×−24.90%)+(30%×6.72%)−1.50%=−16.91%

Next the user is allowed to input data representative of existing sources of retirement income. This would include income sources such as Social Security, company pensions, part-time work, annuities already in payment mode or other streams of income. The input indicates a start year (“from year” data field) and a stop year (“to year” data field) to provide flexibility for income sources that do not extend throughout the entire retirement income plan. The “from year” and “to year” data fields are referenced from the start of distribution of income within the retirement income plan. For example, if a client is currently 63 years old, but they indicate that they want to start their distribution of retirement income at age 67, then year input into the “From year 1” data field would reflect the year in which the client shall be 67 years of age, not the current year. The retirement income planning tool generates data reflecting the ages across which the retirement income shall be distributed in the “From age” and “To age” data fields that display the ages during which clients will receive income distributions in order to help facilitate understanding of the timing of distributions and make sure that the input in the “From Year” and “To Year” data fields are appropriate. The retirement income planning tool is also configured to reflect annual increase factors for each income source. The increases in income sources may include “CPI”, indicating that a particular income source is expected to change with inflation, or a specific percent (including 0.0% for incomes that are fixed in amount).

The retirement income planning tool also allows the user to input data representative of various categories of income needs in retirement. This could be just one “general expense” category or various individual categories, or both. The user is also allowed to input data specifying “additional savings” amounts, such as contributions to an employer sponsored 401(k) or individual IRA plan, that will be added to retirement savings during the retirement income plan. If there are amounts input in the “additional savings” data fields, the retirement income planning tool is configured to accommodate the proposed reduction in income and the future increase in deferred income. This may make sense based on tax treatment or employer matching programs. Since these savings amounts are happening during the years of the income plan, they are added to the total “need” that must be met in retirement. For example, if the total income identified as necessary to satisfy the needs for a given year is $45,000 and the savings amount for that year is $5,000, then a total of $50,000 must be generated to fully meet the income need for that year (ignoring taxes for the moment). If the total income sources for the year equal $30,000, then the program would withdraw $20,000 from retirement savings, but also put $5,000 back in. The retirement income planning tool is also configured to estimate income tax. The income tax estimate is generic and only included to make sure that taxes are not over looked when the listing of “Income Needs” is being reviewed and managed. The details of tax treatment of different sources of income and withdrawals from qualified vs. non-qualified accounts are not reflected in the generic tax estimate of the one embodiment described herein. However, those considerations may be factored into alternative embodiments to determine a reasonable tax rate for this assumption. The income tax estimate is applied to the sum of the income needs listed for a given year (adjusted for inflation or fixed increases) to determine the total need. The calculation is: [Sum of Needs (adjusted)]/(1−tax rate). For example, if the sum of income needs for a given year is $45,000 and the tax rate is 25%, then the total income need for that year will be $60,000. Of the $60,000, $15,000 (25%) is needed to pay income taxes, with $45,000 left to cover other needs.

In determining income gaps in a retirement income plan, the retirement income planning tool processes the financial and personal data inputs and generates a year-by-year projection of income needs illustrating retirement income sources. If the income needs are greater than the income sources in any particular year, then there is an income gap. The retirement income planning tool facilitates filling this income gap using withdrawals from retirement savings and annuity purchases (retirement assets) in accordance with the income planning choices selected. Income gap results are illustrated in a table and a graph. The table starts at the age specified as the start of the detailed plan. The other ages within the plan are flexible in order to highlight specific time periods if there are ups and downs in the income sources and/or income needs. The actual income gap will vary slightly for each scenario projected due to the impact of varying rates of inflation on the income sources and needs.

One of the sources of retirement income is an annuity. The annuity purchased in retirement planning in accordance with the present invention is a lifetime income annuity, which is also referred to as a fixed single premium immediate annuity. The lifetime annuity is incorporated into the income projections when the retirement income plan recommends and the client authorizes the incorporation and purchase of the annuity. Annuity purchases may occur at the beginning of the income distribution plan, thereby building additional income floor, or over time according to the income lock guidelines. In accordance with one embodiment, the income lock guidelines are implemented by following the steps of, first, identifying at least one date within a retirement income plan when it is advantageous to purchase an annuity and providing the customer with an option to purchase and incorporate the annuity revenue into the retirement income plan. The date identified is in accordance with when the annuity payout rate is not greater than the current withdrawal rate. Additional annuity characteristics include identifying and selecting whether the income from an annuity shall be based on one life or two. When two lives are involved, selecting whether there shall be any reduction in the income stream after the first death. The payment mode is also selected (annual, quarterly, monthly) as well as any period of guaranteed payments regardless of whether the annuitant(s) are alive (10 years certain, 20 years certain). The final characteristic is the pattern of income payments. Choices include level payments for life or payments that increase annually at a fixed rate (e.g. 3% or 4%) or payments with increases linked to inflation (CPI).

The calculation of hypothetical annuity purchase rates, in accordance with one embodiment, is based on standard actuarial formulas, the Annuity 2000 mortality table, a specified interest rate and a product load (5%). The specified interest rate is the seven year U.S. Treasury bond plus 1.00%. This approximation reflects the fact that most insurance companies generate investment returns above treasury yields, but they also deduct investment margins and/or product loads for expenses and profit when pricing immediate annuities. The annuity calculation module generates a table of annuity purchase rates for the features indicated and a range of ages and interest rates. The program then looks up the appropriate rate in the table any time an annuity purchase is called for in the plan using current attained age(s) and the seven year U.S. Treasury bond rate. The treasury rates vary each year in each scenario. In this way, the hypothetical annuity rates reflect the potential income available under varying economic conditions in each scenario. These rates are reasonably representative of rates available in the industry, but do not represent any particular annuity product.

The retirement income planning tool also facilitates a process for managing retirement income, allowing a client to input data representative of key decisions associated with management of retirement income over time. One method of facilitating management of retirement income is through the use of an income buffer account, into which a portion of the retirement assets that are maintained as liquid are placed to allow for immediate withdrawal as retirement income. Rather than having all retirement assets in one diversified account and taking withdrawals from that account for income, an amount equal to several years worth of desired income is placed in an account with a guaranteed rate of return (CDs, treasury bonds, etc.). Withdrawals are then taken from this account to generate income over time. The remaining assets are invested in a diversified account. The guaranteed investments in the “Income Buffer” isolate the income stream from short term fluctuations in the investment markets. Gains in the investment account can be used annually to refill the Income Buffer account, up to a specified maximum number of years of income. If there are losses in the investment account, no transfers would be made, but withdrawals could continue from the “Income Buffer”. In the event of a period of prolonged losses in the investment account, a transfer would be made in order to keep a minimum number of years of income in the buffer account.

The data input fields in the retirement income planning tool specify the maximum and minimum years worth of income to be held in the Income Buffer account. A client may choose from one year of income up to any number of years in which they and their financial planner determine is appropriate. If the Income Buffer approach is not considered as part of the retirement income plan, then both the Max Years and Min Years should be set to zero. In accordance with one embodiment, the retirement income planning tool projection function assumes a return on assets within the Income Buffer account to be equal to the annual inflation rate each year plus 1.00%. This is a reasonable representation of returns available on low risk short term investments (CDs, money market funds, inflation adjusted U.S. savings bonds) under various economic conditions but does not assume a specific product or investment. The spread over inflation for the Income Buffer returns would not vary for each client, but could be reset periodically to reflect general changes in market conditions. It is to be understood that it has been contemplated and the system may have the capability to increase or decrease the annual inflation rate to a level to more accurately reflect the returns available on low risk short term investments at a given point in time. This function will allow a client to have the projections more accurately reflect actual market return conditions to the extent the inflation rates in the actual market are not constant and are being modified as often as needed to more accurately reflect market conditions. A hypothetical example illustrating the operation of the Income Buffer is illustrated in Table 2 and 3. The initial amount of assets is $500,000. The maximum number of years in the Income Buffer is 5 years and the minimum number of years in the Income Buffer is 2 years.

TABLE 2

| | Income Buffer Account | | | | | |
|---|---|---|---|---|---|---|
| | | | Transfers from | | Withdrawals | Account |
| | | | Inv Acct | Years in Acct | for income | Balance |
| Year | Return | Inflation | (Beg of Year) | (Beg of Year) | (Beg of Year) | (End of Year) |
| 1 | 4.0% | 3.0% | $100,000 | 5.00 | $20,000 | 83,200 |
| 2 | 4.0% | 8.0% | 19,800 | 5.00 | 20,600 | 85,696 |
| 3 | 4.0% | 1.0% | — | 3.85 | 22,248 | 65,986 |
| 4 | 4.0% | 4.0% | 7,420 | 3.27 | 22,470 | 52,972 |
| 5 | 4.0% | 9.0% | — | 2.27 | 23,369 | 30,787 |
| 6 | 4.0% | 3.0% | 20,158 | 2.00 | 25,473 | 26,491 |
| 7 | 4.0% | 2.0% | 70,774 | 3.71 | 26,237 | 73,870 |
| 8 | 4.0% | 5.0% | 48,255 | 4.56 | 26,761 | 99,178 |
| 9 | 4.0% | 3.0% | 16,085 | 4.10 | 28,100 | 90,650 |
| 10 | 4.0% | 9.0% | — | 3.13 | 28,943 | 64,176 |
| 11 | 4.0% | 2.0% | — | 2.03 | 31,547 | 33,934 |
| 12 | 4.0% | 1.0% | 35,940 | 2.17 | 32,178 | 39,204 |
| 13 | 4.0% | 2.0% | 44,925 | 2.59 | 32,500 | 53,694 |
| 14 | 4.0% | 5.0% | 12,606 | 2.00 | 33,150 | 34,476 |

TABLE 3
Investment Account

| | Transfers to | | | Account Balance |
|---|---|---|---|---|
| | Buffer | | Gains/ | (End of Year) |
| Year | (Beg of Year) | Return | Losses | $500,000 |
| 1 | $100,000 | 8.0% | $32,000 | 432,000 |
| 2 | 19,800 | −10.0% | −$41,220 | 370,980 |
| 3 | — | 2.0% | $7,420 | 378,400 |
| 4 | 7,420 | −5.0% | −$18,549 | 352,431 |
| 5 | — | −3.0% | −$10,573 | 341,858 |
| 6 | 20,158 | 22.0% | $70,774 | 392,474 |
| 7 | 70,774 | 15.0% | $48,255 | 369,955 |
| 8 | 48,255 | 5.0% | $16,085 | 337,785 |
| 9 | 16,085 | −5.0% | −$16,085 | 305,615 |
| 10 | — | −2.0% | −$6,112 | 299,503 |
| 11 | — | 12.0% | $35,940 | 335,443 |
| 12 | 35,940 | 15.0% | $44,925 | 344,428 |
| 13 | 44,925 | −5.0% | −$14,975 | 284,528 |
| 14 | 12,606 | 8.0% | $21,754 | 293,676 |

Year one illustrates a move of 5 years of future income. 5×$20,000=$100,000, which is transferred into the Income Buffer account. $20,000 of the account is withdrawn in year one. In year two, in view of inflation which is estimated at 3%, the desired income is $20,600 (1.03×$20,000=$20,600). Year one posted gains of $32,000. $19,800 of year one's gains are transferred into the Income Buffer account in year two in order to maintain five years of future income. (5×$20,600=$103,000) ($103,000 desired−$83,200 prior balance=$19,800 transfer). As table 2 illustrates, during year two, $20,600 is withdrawn from the Income Buffer account. Table 3 illustrates that during year two, the investment account had losses $41,200. Accordingly, during year three, there is no transfer of assets from the investment account to the income buffer account. But, there is a withdrawal of assets from the income buffer account in year three of $22,248, which is the equivalent of $20,600 adjusted for inflation at 8% ($20,600×1.08 for inflation). In year 6, as table 2 illustrates, the assets to be withdrawn from the Income Buffer account is $25,473. In accordance with one embodiment, the management method is to maintain the Income Buffer account at a minimum level that is the equivalent of at least two years of withdrawal income, which is $50,946. During the prior year, year five, the balance in the Income Buffer account was $30,787. Even though there have been prior year losses in the Investment Account, the method of maintaining at least two years of withdrawal income necessitates an asset transfer of $20,158 from the Investment account to the Income Buffer Account. ($50,946 minimum−$30,787 prior balance=$20,158).

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (a) as a sequence of computer implemented steps running on a computing system and/or (b) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

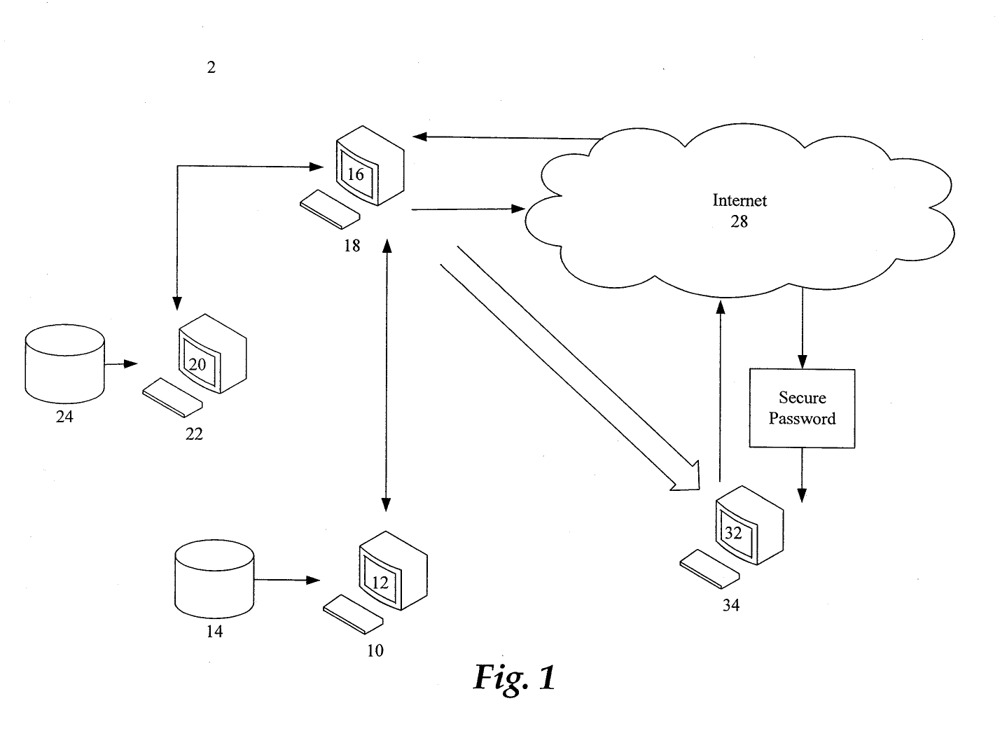

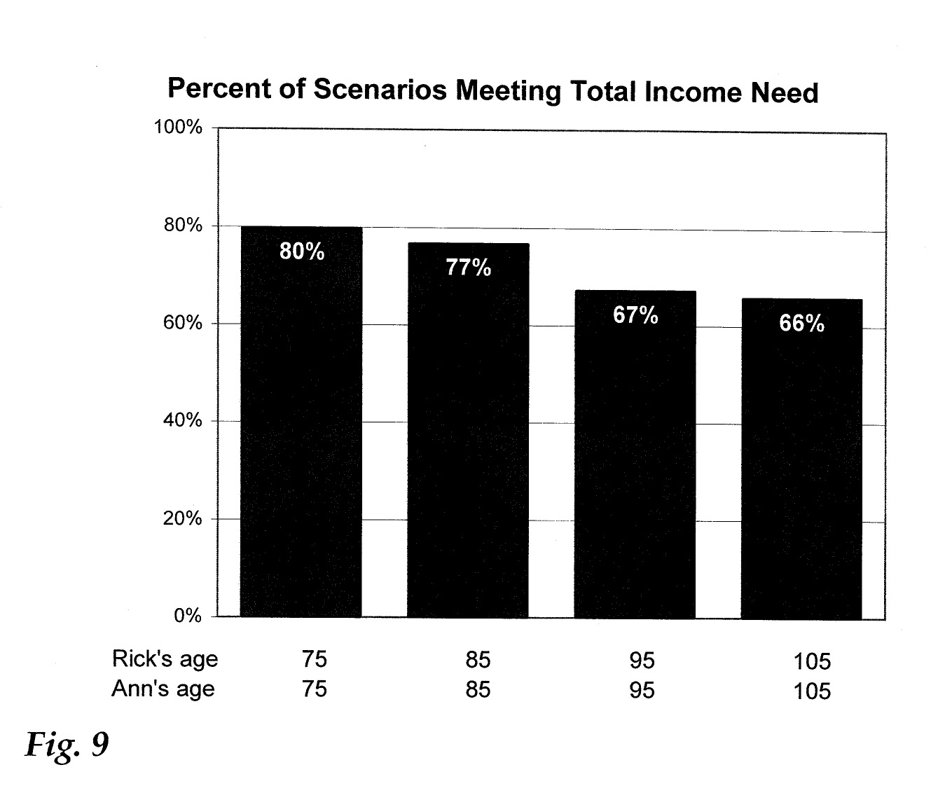

Referring more particularly to the Figures, FIG. 1 illustrates an exemplary system 2 upon which the modules that comprise the retirement income planning tool operate in order to facilitate retirement income projections, management, monitoring and planning. The retirement income planning tool is comprised of a client module 32, a scenario generation module 12, annuity calculation module 20, and projection module 16. The client module 32, operative in a computing environment 34, has at least data storage, a processor and a data entry device, facilitates client personal and financial data entry into a plurality of data fields within the module. Prior to data entry, the system user accesses the client module 34 by entry of a password. The client module system 34 communicates with the system 18 encompassing the projection module 16 through a secure internet 28 connection. Client financial data input into the data fields within the client module 32 are transmitted to the projection module 16, which contains guideline algorithms for generating asset investment projections. The projection module 16 is operatively configured for communication with the annuity calculation module 22 and a scenario generation module 12. The annuity calculation module 22 performs the function of determining annuity payouts in view of annuity purchase amounts determined by the projection module 16. The scenario generation module 12 is operatively configured to access data within data storage 14 that is representative of the historical performance of investment vehicles, which when processed in view of a client's identified asset level and selected investment vehicle, projects the investment performance of the client's assets. The scenario generation module 12 uses several hundred “random” investment scenarios that are generated using complex statistical methods that are operative within the scenario generation module 12 in order to generate data representative of investment scenarios for the client's assets level. The investment scenarios have statistical characteristics similar to those that have been observed historically. These characteristics include the average value and the annual variation for factors such as interest rates, market returns, and inflation, as well as any correlation between the factors. Each of the random scenarios projected in the simulation determines if the total income need for a given year is satisfied. The percentage of the scenarios that meet the total income need is the ratio of scenarios in which the total need is met in every year of the projection to the total number of scenarios considered, illustrated in FIG. 9.

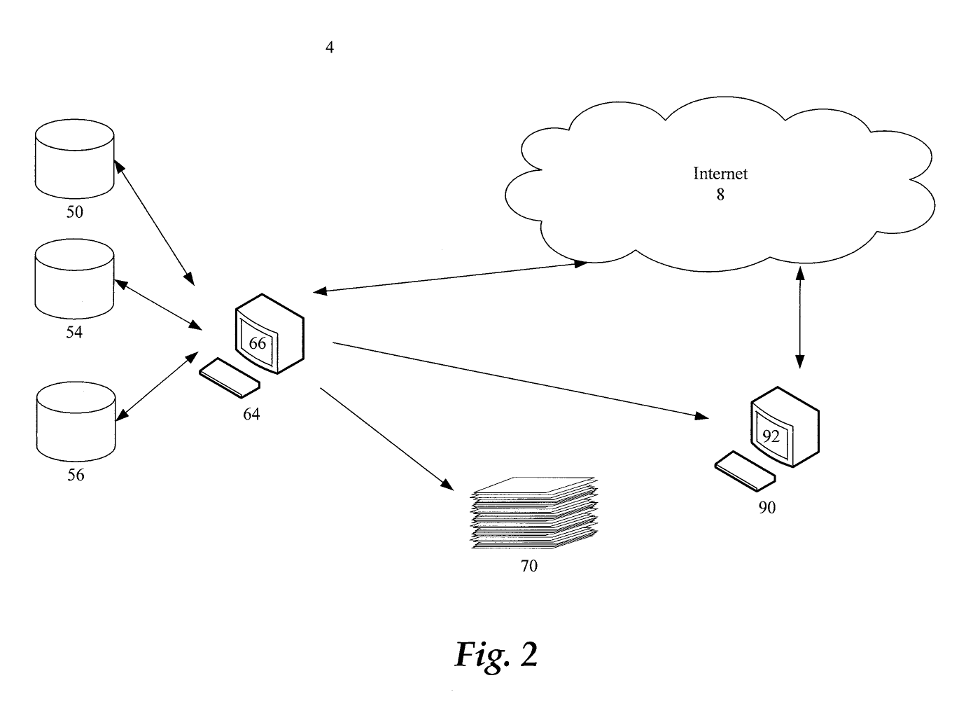

FIG. 2 illustrates an exemplary system used for ongoing monitoring of the client's retirement plan. The system includes a client computer 92 used to access the system and send any updated client information (changes in goals, changes in Social Security or pension benefits, etc) to the calculation module 66. The calculation module 66 contains the algorithms for applying the planning and management guidelines such as Income Lock, Income Extender and Income Buffer Account. The calculation module 66 collects data from the plan database 50 which stores the original goals and plan choices developed by the client as well as past performance against the plan. The calculation module 66 also collects data regarding current account balances 54 and current economic conditions 56, such as recent inflation rates, recent market returns and current annuity payout rates. The calculation module 66 collects all this information and creates a monitor report that includes data representative of historical investment performance against the plan and recommendations for actions based on current conditions and the decision rules of the guidelines. The report can be delivered to the client via paper 70, over the internet (with secure password), or directly to the client computer via electronic transmission (e-mail).

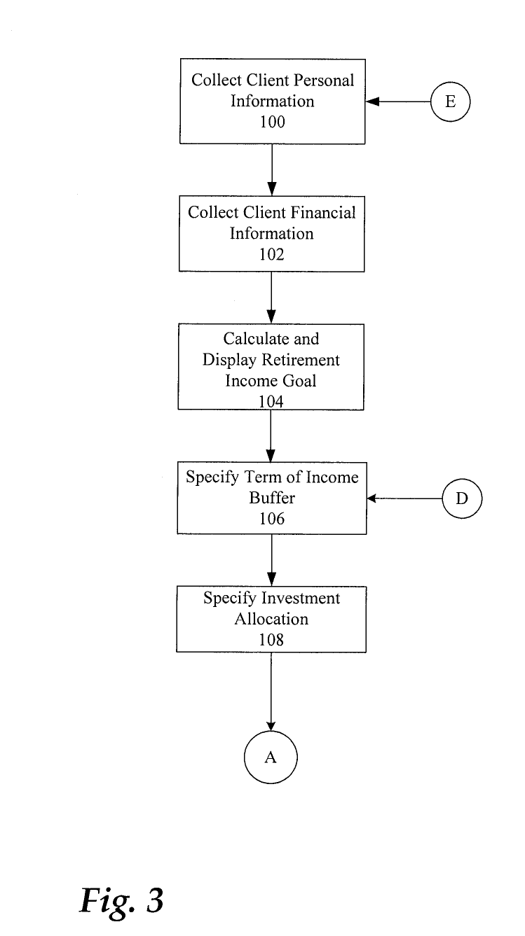

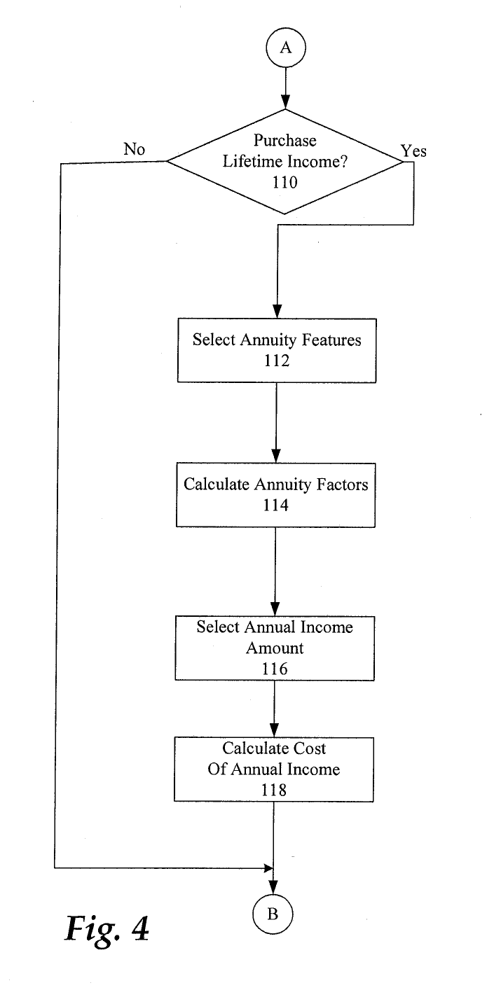

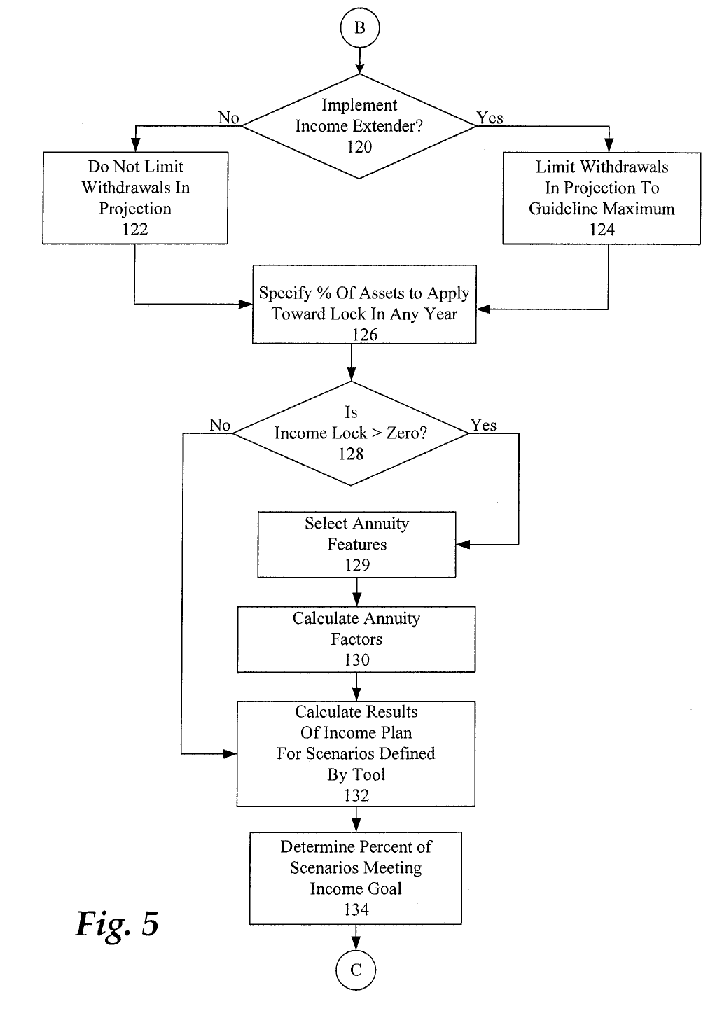

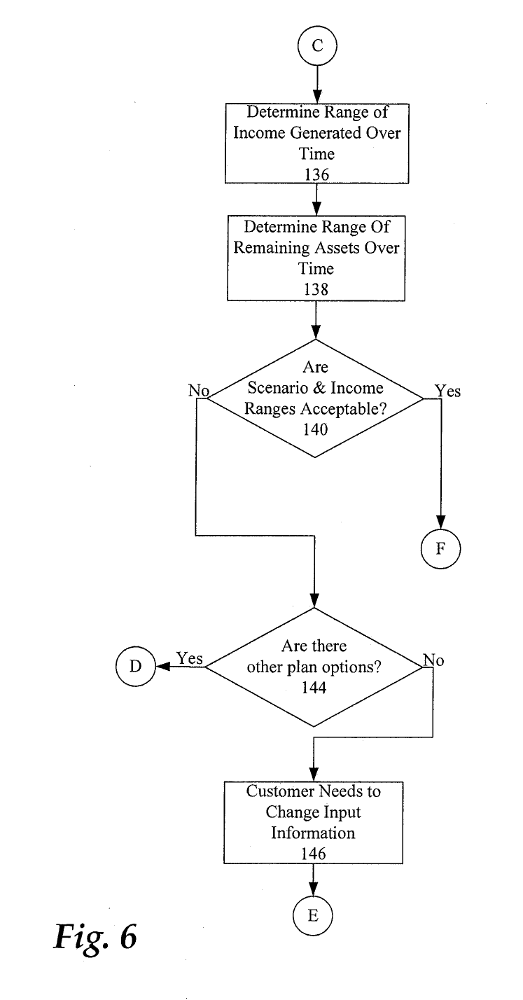

The method of planning and managing retirement income is illustrated in FIGS. 3 through 7, wherein a first step is to collect a client's personal 100 and financial 102 information for input into the retirement income planning tool 100. This data includes at least the client's profile information, such as client name, client age, current value of retirement savings, income needs, income sources, additional savings, estimated effective tax rate and investment allocation. In response to the client data inputs, the retirement income planning tool generates and displays a client's retirement income goals 104. Next, a client is presented with a plurality of income plan options. One option is for the client to determine whether they want to use an income buffer and, if so, to specify the term of the income buffer 106. This encompasses defining the maximum number of years of an income buffer. Assets within a retirement income plan are managed in a manner that facilitates meeting the client's retirement income needs. In that regard, the assets are managed through the use of at least two accounts, an income buffer account and a growth account. The income buffer account includes a portion of the retirement assets that are maintained as liquid in order to allow for the withdrawal of assets as retirement income over a defined period of time. A client has to specify the term 106 of the income buffer in order to determine the amount of assets to be stored in the income buffer account. Next, the client specifies the allocation of the investment assets within the growth account 108. In accordance with one embodiment, a client is provided with five choices representing a range of investment allocations. The specific allocations are modeled as a mix of large company stock funds and corporate bond funds as indicated in table 1 above. Next, the client has the option of purchasing a lifetime guaranteed income 110, through the purchase of an annuity. If the client chooses to purchase an annuity, the user is then allowed to select annuity features 112. The annuity features are aspects such as, whether the annuity is based on one person's life; whether it is a joint annuity; whether the payments are constant or change over time, etc. Annuity features are selected so that the client understands the type of annuity to purchase when projections are being performed. Next, the retirement income planning tool calculates the annuity factors 114 so that the factors can be utilized in the generation of projections. The client also has to select an amount of annual lifetime income that they desire to receive 116. The retirement income planning tool determines the costs 118 of the annual income and includes the income and cost amounts in the income calculations and projections for the retirement income plan. If the client does not want to purchase lifetime income through the annuity 110, or following the selection of the annual amount of lifetime income 116 and the calculations of costs of annual annuity income 118, the client determines whether they would like to apply the income extender guidelines 120. These guidelines are the rules that govern withdrawal of assets from the income buffer account during retirement. The income extender guidelines also serve as an early stage warning indicator that is applied to retirement income asset withdrawals, which provide notice to the client and a financial advisor of when retirement income withdrawals are reaching levels that are not sustainable over the life of a retirement income plan.

During a retirement plan, withdrawal levels, which initially may have been projected as sustainable over the life of the plan, in some instances, as a result of market forces, become unworkable over the life of the plan, requiring withdrawals to be decreased. In accordance with one embodiment, the “Income Extender” guidelines recommend that withdrawals shall not exceed 8% of a client's retirement assets in any given year. This maximum recommended withdrawal rate increases to 9% for ages 85-89 and 10% for ages 90 and above. If the client selects to implement the income extender guidelines 120 as part of the plan, the client is selecting to limit the withdrawals in the projections to a maximum guideline 124. Next, the client has to specify the percentage of assets to apply toward an “Income Lock” (asset withdrawal lock) in a given year 126. This step is defining for the projections, when the situation arises and the annuity lines up with the current withdrawal rate, then the client is withdrawing the percent of assets from the income buffer account in order to buy an annuity in accordance with the features previously selected. This is done by the client in an effort to lock in an amount of guaranteed income for the rest of the client's life. The Income Lock a client may select ranges from 0% to 100%. Following entry on an income lock on a percentage of the assets from the income buffer that shall be used to buy an annuity, the retirement income planning tool determines if the percentage of assets selected is greater than zero 128.

If the client has chosen to apply the “Income Lock” guidelines in their plan, they will have selected a percentage of assets for the income lock to be greater than zero. Next, the client is prompted by the retirement income planning tool to select annuity features 129. The retirement income planning tool then calculates the annuity factors 130 so that the factors can be utilized in the generation of projections. Next, the results of the income plan are generated in view of the scenarios previously defined 132. When the retirement income planning tool checks to determine the percentage of assets identified by the client for use in the purchase of an annuity 128 and it is determined that the client has selected an allocation of zero percent of the assets, the retirement income planning tool skips steps 129 and 130 and generates the results of the income plan in view of the scenarios previously defined 132. The income plan results include a determination of the percentage of scenarios that meet income goals 134, a determination of the range of income generated over time 136 and determination of a range of the retirement assets over time 138. These results are displayed and illustrated graphically by the retirement income planning tool, FIGS. 9, 10 and 11. If the percentage of scenarios that meet the income goals, the income ranges and the range of asset values are acceptable 140, the proposed retirement income plan is implemented 142. If the proposed income ranges are not acceptable 140, the client is allowed to pursue alternative plan options 144 such as, modifying the term of the income buffer 106, the investment allocation 108 and whether to purchase annuities 110. Modifying these data inputs of the income plan in order to change the plan options allows the client to create a new retirement plan wherein a percentage of scenarios meet the income goals 134 and the range of income 136 and retirement assets generated over time 138 is acceptable, facilitating the implementation of the retirement income plan 142. On the other hand, if the proposed income ranges are not acceptable 140, and there are no alternative retirement plan options, the client needs to change the client input data 146, by modifying personal 100 and financial 102 information. This results in the generation of new retirement income goals.

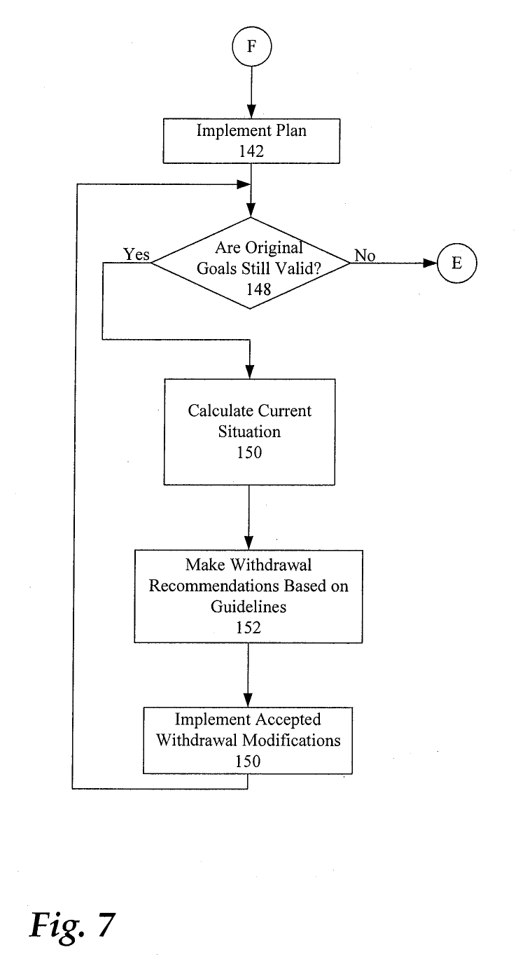

The method of monitoring an income plan and any ongoing adjustments to the plan in response to current market conditions are illustrated in FIG. 7. Following the implementation of the retirement income plan 142, at some specified point in time or based on some lapse of a previously defined period of time, the client is prompted to review the retirement income plan. At this time, the retirement income planning tool seeks a determination of whether the original retirement goals 148 remain valid. If the goals are not valid, the user is prompted to change the client input data 146, by modifying personal 100 and financial 102 information. This results in the generation of new retirement income goals. If there is a determination that the retirement income plan goals remain valid 148, there is a determination of the current situation by collection of current information and calculation of the guidelines 150. A determination of the current situation includes a comparison of planned income to actual income received under the plan to date. The calculation of the guidelines requires collection of data regarding current account balances, planned income and withdrawals, recent inflation and current lifetime annuity purchase rates. In view of the guideline calculations, recommendations are made on the level of withdrawals that can be made from the income buffer and investment growth accounts 152. The recommendation shall be to continue desired withdrawals, to reduce the withdrawals, buy an immediate annuity with a portion of the assets, move money from the investment growth account to the income buffer account, or reallocate the growth account assets in order to maintain the desired investment allocation 152. Next, there is implementation of the withdrawal recommendations 154. After the passage of some previously defined period of time, the method cycles back through to prompt the user to determine whether the original plan goals continue to be valid 148 and depending on whether the plan goals are valid or not, determines the resultant steps that are performed.

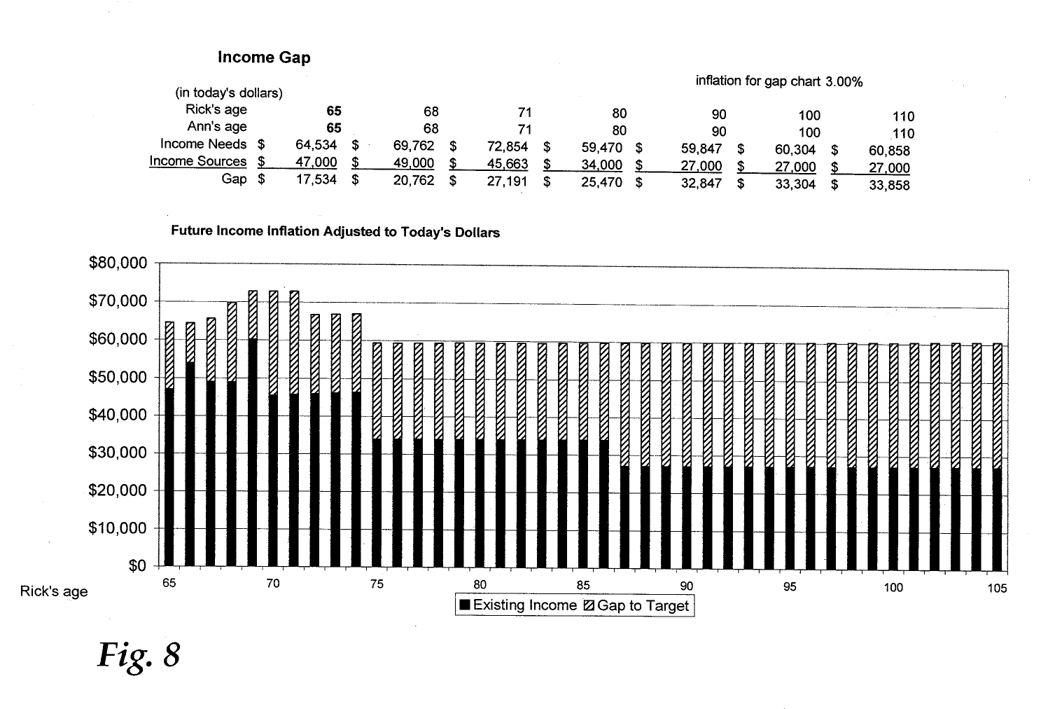

FIG. 8 is an illustration of retirement income goal, whereby the client's desired income is illustrated along with income from retirement income sources, such as social security benefits and company pension plans. All amounts in FIG. 8 are inflation adjusted to today's dollars to equate the purchasing power of income amounts today and in the future. As FIG. 8 illustrates, at age 65, the client has defined their respective retirement income needs or the target income level to be $64,534.00. The income the client anticipates receiving from retirement income sources other than assets is $47,000.00. Accordingly, there is an income shortage or gap of $17,534.00. The income gap must be filled by withdrawing funds from the client's investment assets. In this example, the client must utilize $17,534.00 of their assets to meet their target retirement income of $64,534.00. At age 68, the client has defined their target income level to be $69,762.00. The income the client anticipates receiving from retirement income sources other than assets is $49,000.00. Accordingly, there is an income shortage or gap of $20,762.00. The income gap must be filled by withdrawing funds from the client's investment assets. In this example, the client must withdraw $20,762.00 from their investment assets to meet their target retirement income of $69,762.00. At age 71, the client has defined their target income level to be $72,854.00. The income the client anticipates receiving from retirement income sources other than assets is $45,663.00. Accordingly, there is an income shortage or gap of $27,191.00. The income gap must be filled by withdrawing funds from the client's investment assets. In this example, the client must withdraw $27,191.00 from their investment assets to meet their target retirement income of $72,854.00. At age 80, the client has defined their target income level to be $59,470.00. The income the client anticipates receiving from retirement income sources other than assets is $34,000.00. Accordingly, there is an income shortage or gap of $25,470.00. The income gap must be filled by withdrawing funds from the client's investment assets. In this example, the client must withdraw $25,470.00 from their investment assets to meet their target retirement income of $59,470.00. At age 90, the client has defined their target income level to be $59,847.00. The income the client anticipates receiving from retirement income sources other than assets is $27,000.00. Accordingly, there is an income shortage or gap of $32,847.00. The income gap must be filled by withdrawing funds from the client's investment assets. In this example, the client must withdraw $32,847.00 from their investment assets to meet their target retirement income of $59,847.00. At age 100, the client has defined their target income level to be $60,304.00. The income the client anticipates receiving from retirement income sources other than assets is $27,000.00. Accordingly, there is an income shortage or gap of $33,304.00. The income gap must be filled by withdrawing funds from the client's investment assets. In this example, the client must withdraw $33,304.00 from their investment assets to meet their target retirement income of $60,304.00. At age 110, the client has defined their target income level to be $60,858.00. The income the client anticipates receiving from retirement income sources other than assets is $27,000.00. Accordingly, there is an income shortage or gap of $33,858.00. The income gap must be filled by withdrawing funds from the client's investment assets. In this example, the client must withdraw $33,858.00 from their investment assets to meet their target retirement income of $60,858.00.

FIG. 9 is a graphic illustration of the percent of scenarios that meet the total income targets in defined years. The percentage of the scenarios that meet the total income need is the ratio of scenarios in which the total need is met in every year of the projection to the total number of scenarios considered. Because some of the income management choices can result in small adjustments to projected income, there is a sensitivity feature to define whether the income need is met in every year. This sensitivity is set at 98%. For example, if the total income need for a given year is $50,000, then generating an income greater than $49,000 (98% of $50,000) is considered to meet the need in that year. This sensitivity feature prevents small deviations in one or two years from classifying a particular scenario as a “failure” for purposes of this metric. As illustrated in FIG. 9, 80 percent of the scenarios meet the target income from ages 65 through 75. Through age 85, the percentage of scenarios meeting the target income is 77% and by age 95, the percentage of scenarios meeting the target income drops to 67%. At age 105, the percentage of scenarios meeting the target income is 66%.

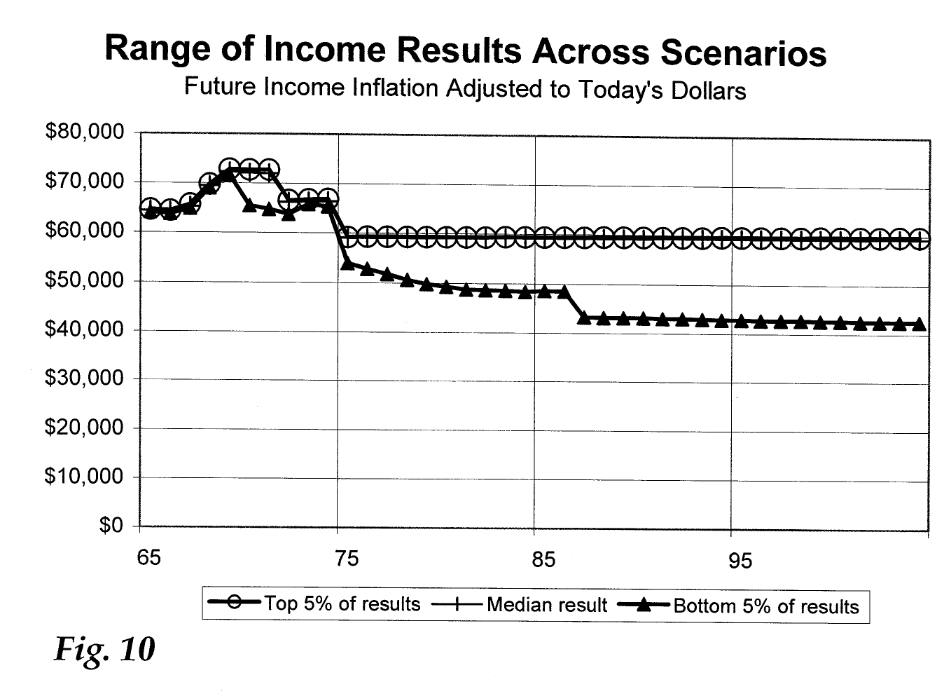

FIG. 10 is a graphic illustration of the range if income results across scenarios. Each scenario may generate a different income result based on the varying patterns of investment returns and inflation. The retirement income planning tool illustrates the level and timing of income over the range of scenarios projected. It demonstrates the timing and severity of potential changes in income for a retirement income plan. The range of potential income results is represented by showing the top 5%, the median and the bottom 5% of results. For many retirement income plans, the top 5% of results and even the median result are equal to the planned income, so only the bottom 5% line may show a different pattern. The income amounts in the chart are inflation adjusted back to today's dollars to equate the purchasing power of income between scenarios with differing levels of inflation. As shown in FIG. 10, the top 5% of scenarios and the median result both equal the full target income through age 105. The bottom 5% of results show a slight reduction in income in the first 10 years, with continued gradual reductions to an ultimate level of just over $40,000. Since these amounts are inflation adjusted to today's dollars, it is possible that actual income in these bottom scenarios is going up slightly or staying level, but it is not rising fast enough to keep pace with inflation, so the purchasing power of the income in declining.

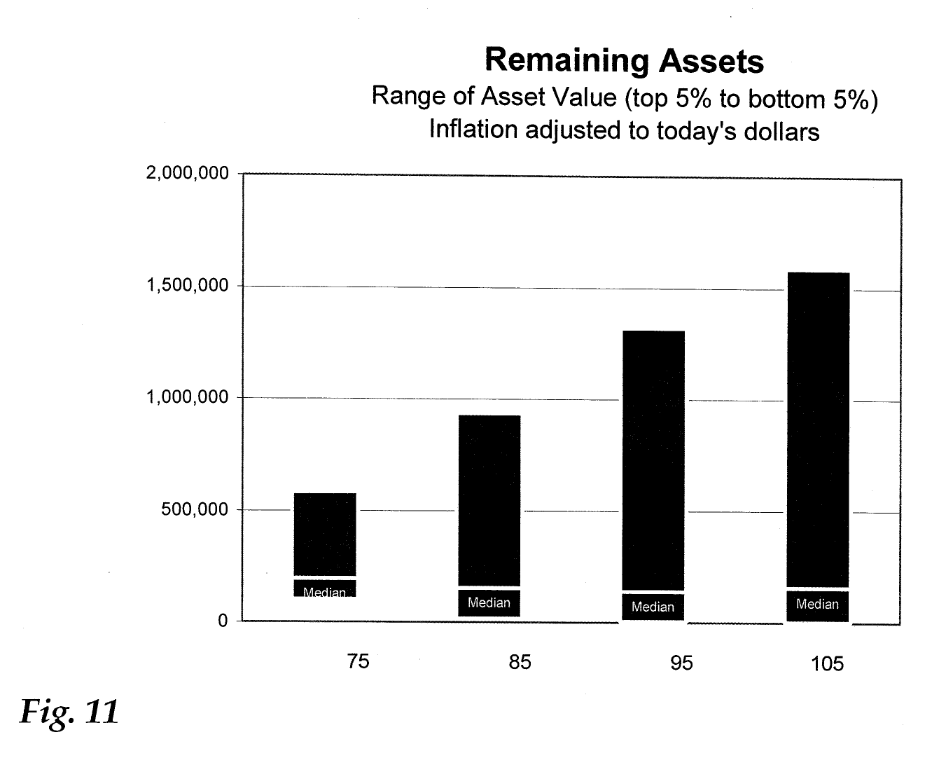

FIG. 11 is a graphic illustration of the range of the remaining asset values throughout the projection. These amounts are inflation adjusted back to today's dollars to equate the purchasing power of the remaining assets between scenarios with differing levels of inflation. In this example, at age 75, the top five percent of scenarios indicate that there will be approximately $580,000.00 of assets remaining. The bottom five percent of scenarios indicate that there will be approximately $100,000.00 of assets remaining at age 75. The median of the scenarios indicate that there will be approximately $200,000.00 of assets remaining at age 75. At age 85, the top five percent of scenarios indicate that there will be approximately $1,000,000.00 of assets remaining. The bottom five percent of scenarios indicate that there will be approximately $20,000.00 of assets remaining at age 85. The median of the scenarios indicate that there will be approximately $150,000.00 of assets remaining at age 85. At age 95, the top five percent of scenarios indicate that there will be approximately $1,300,000.00 of assets remaining. The bottom five percent of scenarios indicate that there will be approximately $0.00 assets remaining at age 95. The median of the scenarios indicate that there will be approximately $140,000.00 of assets remaining at age 95. At age 105, the top five percent of scenarios indicate that there will be approximately $1,600,000.00 of assets remaining. The bottom five percent of scenarios indicate that there will be approximately $0.00 of assets remaining at age 105. The median of the scenarios indicate that there will be approximately $150,000.00 of assets remaining at age 105.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

1. A method of monitoring and managing retirement income through use of a retirement income planning tool that facilitates the generation of a retirement income plan in response to processing projected assets and retirement compensation levels, the method comprising the steps of:
in a computer system:
(a) inputting into the income planning tool financial data representative of a customer's desired retirement income, assets and retirement compensation;
(b) allocating said assets into at least one investment vehicle in response to data input by said customer, wherein said at least one investment vehicle is comprised of an asset performance projection module configured to project the performance of an investment strategy using the customer's investment assets in a plurality of alternative scenarios, wherein each investment scenario is representative of potential future market conditions;
(c) generating a retirement income plan comprised of at least data representative of projected retirement compensation, projected asset levels and projected asset withdrawals, wherein said projected assets are comprised of data representative of the projected performance of said assets processed by said performance projection module; and
(d) comparing said retirement income plan to said desired retirement income levels in order to identify periods in which said retirement income plan projects income levels to be lower than said customer's desired income levels, and when periods are identified in which said retirement income plan projects income levels to be lower than said customer's desired income levels, facilitating modification of said retirement financial data input into the income planning tool in order to generate an updated retirement income plan.

2. The method of claim 1 further including the step of identifying at least one date within a retirement income plan when it is advantageous to purchase a single premium immediate annuity and providing said customer with an option to incorporate said single premium immediate annuity into said retirement income plan, wherein said date identified is in accordance with when the annuity payout rate is not greater than the current withdrawal rate.

3. The method of claim 1 wherein said assets are comprised of at least one of an IRA, 401(k), variable annuity, CD, fixed annuity, bank savings, 457, 403b, mutual funds, and general securities.

4. The method of claim 1 wherein said asset withdrawal values equal the difference between desired retirement income levels for a period of time and retirement compensation during said period of time.

5. The method of claim 1 wherein the data input by said customer is representative of the risk said customer identifies as acceptable in association with investing said assets.

6. A method of monitoring and managing retirement income in response to changes in retirement compensation and in the value of retirement assets, the method comprising the steps of:
in a computer system:
(a) inputting retirement financial data into a retirement income planning tool, wherein said retirement financial data is representative of a customer's desired retirement income, retirement compensation and retirement assets;
(b) allocating said retirement assets into at least one investment vehicle comprised of an asset performance projection module configured to project the performance of an investment strategy using the customer's investment assets in a plurality of alternative scenarios, wherein each investment scenario is representative of potential future market conditions and said at least one investment vehicle is selected based upon a risk level, to which said customer is comfortable, and rate of growth necessary for said retirement assets to reach a level needed to achieve said customer's desired retirement income;
(c) generating data representative of a retirement income plan, wherein said retirement income plan is comprised of said customer's retirement compensation and projected withdrawals from said retirement assets;
(d) comparing said retirement income plan to said desired retirement income in order to identify periods in which said retirement income plan projects said retirement income to be lower than said customer's desired retirement income; and;
(e) when periods are identified in which said retirement income plan projects retirement income to be lower than said customer's desired retirement income in response to changes in the value of said retirement assets, modifying said retirement income plan by changing the level of withdrawals from said retirement assets.

7. The method of claim 6 wherein the at least one investment vehicle is comprised of at least two accounts, an income buffer account and a growth account, wherein said income buffer account is comprised of a portion of said retirement assets that are liquid for withdrawal as retirement income over a defined period of time.

8. The method of claim 7 wherein said defined period of time is annual.

9. The method of claim 7 wherein when said changes in the value of said assets is an annual increase in the value of said assets, wherein an amount of said annual increase in value of said assets up to an amount equivalent to an annual withdrawal amount is distributed to said buffer account.

10. The method of claim 6 wherein said asset withdrawal values equal the difference between retirement income levels and annual retirement compensation.

11. The method of claim 6 wherein the assets are comprised at least one of an IRA, 401(k), variable annuity, CD, fixed annuity, bank savings, 457, 403b, mutual funds, and general securities.

12. The method of claim 6 further including the step of identifying at least one date within a retirement income plan when it is advantageous to purchase a single premium immediate annuity and providing said customer with an option to incorporate said single premium immediate annuity into said retirement income plan, wherein said date identified is in accordance with when the annuity payout rate is not greater than the current withdrawal rate.

13. The method of claim 6 further including the generation a warning indicator when withdrawals from said retirement assets reach a level that is not sustainable over the life of said retirement income plan.

14.-20. (canceled)
